(19) United States
(12) Patent Application Publication
(10) Pub. No.: US 2002/0069116 A1
(43) Pub. Date: Jun. 6, 2002

(54) E-commerce referral tracking method and system

(76) Inventors: Zentaro Ohashi, San Mateo, CA (US); Andrew Raskin, San Francisco, CA (US); Shanti Bergel, San Francisco, CA (US)

Correspondence Address: GARY CARY WARE & FREIDENRICH, 1755 EMBARCADERO, PALO ALTO, CA, 94303-3340, US

(21) Appl. No.: 09/728,433

(22) Filed: Dec. 1, 2000

(51) Int. Cl. G06F 17/60

(52) U.S. Cl. 705/26

(57) ABSTRACT

System and method for interacting with customer end user computers and merchant end user computers so that merchant end user information and merchant end user recommendations are received from a first customer end user computer and forwarded, with an added hypertext link, to a second customer end user computer. The system and method store customer end user and merchant information end user information, and customer end user—merchant end user interactions, for example for customer loyalty premiums.

### FIELD OF THE INVENTION

The invention relates to web-based commercial transactions (e.g., e-commerce) with remote data accessing where independent computers are linked by one or more interconnected networks, as an internet, especially where embedded links are used to call and retrieve pages from web sites, and more particularly where the embedded links are created as part of a customer recommendation or referral system. More particularly the embedded links are called from a merchant page by a link to a server. The server creates hypertext links for the “referred to” customer site, and uses the link to both (1) serve the merchant page to the “referred to” customer and (2) organize and inter-relate data or files of the customers and the merchant, for example, as part of an incentive program, e.g., to award premium credit resulting from referring a new customer to an e-commerce merchant.

### BACKGROUND OF THE INVENTION

With the increasing popularity of the Internet and the World Wide Web, it has become common for merchants to set up Web sites for marketing and selling goods. Via this site, consumers can access and place orders from the merchant's online catalog. One problem commonly encountered by online merchants is an inability to effectively draw new customers to their web site, and thereafter market goods via their Web sites to these new customers.

This inability to efficiently attract potential consumers to their Web sites has required a resort to inefficient marketing strategies. One way of attracting consumers has been to market the site through other media, as television, newspaper and Internet advertisements. However, advertising a site using conventional methods can be expensive, can consume significant human resources, and may not even be effective.

What would be desirable would be a recommendation system based upon based upon recommendations from “friends”, “pals”, or “buddies” personally known to the consumer. Preferably, this would be a software system and method for enabling an Internet sales entity, that is, a “merchant-user,” to “grow” a customer base based upon directed recommendations of new customers from its existing customer base. The system and method for customer recommendations to “friends” should be implemented in part by software that runs on the merchant-user's Web site, or, especially where rewards or premiums are involved, a vendor's web site. Through this site, an existing customer can enroll (via an automated registration process), and can then “recommend” friends as customers.

### SUMMARY OF THE INVENTION

The invention is a web-based, e-commerce, method and system for retaining and rewarding customer loyalty.

The system and method operate on the principle of “tell a friend about us (a merchant or tradesman), and if the friend buys from us, you get a finders fee, and if their friends buy from us, we'll give you a bigger finder's fee.”

This is accomplished by using the method and system for tracking recommendations made over a network of a web sites on a network. The recommendations or referrals are made by a first user at a first browser. The recommendations or referrals are made to a second user at a second browser. Both of the users are on a network as are the merchant and a tracking or score keeping computer or server.

The first user or customer, while at a web site, for example, a merchant web site, enters a recommendation or referral of a possible customer The recommendation or referral is initiated by clicking on a GIF or icon or the like, on the merchant's web site, which opens up a box for entry of the second user customer's e-mail address. This is then sent, for example, as part of a URL, from the first customer's or user's browser, to the tracking server. This recommendation or referral is received at the tracking server, where the referral or recommendation data of the recommended web site and data of the user at the second browser for whom the recommendation is made. This may be converted to the merchant's web address, and the web address is sent to the second end user or customer.

Data about the users are stored at the tracking server. The tracking server also provides an applet having a link to the recommended web site to the second user at the second browser.

The first user or customer may or may not be named or identified to the second user, or the merchant. The tracking server provides an applet provided to the second user at the second browser. This applet has a link to the recommended web site, and may identify the first user at the first browser as the recommender of the second user at the second browser to the web site.

The method and system of the invention tracks referrals and the actions of the referred customer (and lower level referrals) for the purpose of rewarding customer loyalty. This includes identifying the interaction of the second user or customer with respect to a specific merchant and a specific referring first user. The interaction, which may be a click through, or a transaction, such as an inquiry, a registration, a request for more information, or a sale, and an associated value. The recommending first user, the recommended second user, the merchant, and the transaction are all tracked and stored at the tracking server. More particularly, the tracking server has stored or algorithmically assigns interaction values to interactions taken by second users or customers referred to a web site or merchant by a first user or customer. The tracking server also assigns referral values to the first user based upon the interactions taken by the second users referred to web sites by the first user.

The storage of this information is preferably in the form of a string, where the string is of the form

A=B+*C+D(E+!F(G+H))

where A represents the first user at the first browser, and B, C, D, E, and F represent second users at second browsers, where A sent referrals to B, C, and D as second users at second browsers, and D, thereafter as a first user at a first browser sent referrals to E, and F as second users at second browsers, and F, thereafter as a first user at a first browser, sent referrals to G and H as second users at second browsers, and wherein “*C” indicates that C as a second user at a second browser clicked through on the referral, and “!F” indicates that F performed an affirmative interaction with respect to the recommendation of the recommended web site.

The string may be stored as a linked list or as a relational database with sets of elements and relations in the relational database representing the customers, merchants, interactions, and values

The method and system of the invention facilitate tracking recommendations of e-commerce merchants by one customer to another customer, with the customers having identifying indicia text data (cookies). This is accomplished by: receiving at a tracking server a recommendation of a merchant web site from a first customer to a second customer. This recommendation includes recommendation data of the recommended merchant web site and identification data of the second customer for whom the recommendation is made. This data is both stored at the tracking server and provided to the second customer, e.g., in the form of an applet having a link to the recommended merchant web site. This applet further identifies the first customer as the recommender of the second customer to the e-commerce merchant web site, and identifies the interactions of the second customer with respect to the recommendation to the recommended e-commerce merchant web site.

This information is stored at the tracking server, for example, in a string of the form

A=B+*C+D(E+!F(G+H))

where A represents the first customer, and B, C, D, E, and F represent second customers, where A sent referrals to B, C, and D as second customers, and D, thereafter as a first customer sent referrals to E, and F as second customers, and F, thereafter as a first customer, sent referrals to G and H as second customers, and wherein “*C” indicates that C as a second customer clicked through on the referral, and “!F” indicates that F performed an affirmative interaction with respect to the recommendation of the recommended web site.

Interaction values may be retrieved from a database or assigned by the tracking server. This results in assigning interaction values to interactions taken by second customers referred to a web sit, and assigning referral values to the first customer based upon the interactions taken by the second customers referred to web sites by the first customer.

The method of the invention is typically carried out in a system controlled and configured for interacting with customer end user computers and merchant end user computers so that merchant end user information and merchant end user recommendations are received from a first customer end user computer and forwarded, for example, with an added hypertext link, to a second customer end user computer. The system also stores customer end user and merchant information end user information, and customer end user—merchant end user interactions.

The system includes a host server and a database server (including the tracking server).:

The host server is adapted to receive recommendations from the first customer end user browser and transmit a hypertext link implementing the recommendations to the second customer end user browser and to the recommended merchant end user. The host server is also configured and controlled to receive customer end user—merchant end user interaction data from the second end user.

The database server has one or more business object databases including hypertext links for sending customer end user data and receiving interaction data, an e-mail database, an e-mail address list table, a user table. The database server also includes a tracking database for receiving and recording first customer end user recommendations and second customer end-user interactions, and providing data for customer end user reports.

The system is controlled and configured to deliver hypertext links to the second customer end user. These hypertext links are recommendation links that mark the second customer end user as having been recommended to the merchant end user using a cookie. After receiving this data the system is controlled and configured to redirect the second customer end user to the merchant end user using the cookie.

The system is also controlled and configured to receive indicia of second customer end user interactions with the merchant end user.

A further aspect of the invention is that the tracking database is configured and controlled to store the identities of the first customer end user, the second customer end user, the merchant end user, and the interaction taken by the second customer end user with the merchant end user as a string. Also, the system is controlled and configured to assign interaction values to interactions taken by second customers referred to a web site by a first customer, to assign referral values to the first customer based upon the interactions taken by the second customer referred to web sites by the first customer, and to store values assigned to the first customer.

The database server, containing the tracking capability, referred to herein as the tracking server and equivalently as the tracking database stores the referral and interaction data as :string is of the form

A=B+*C+D(E+!F(G+H))

where A represents the first customer end user, and B, C, D, E, and F represent second customer end users, where A sends recommendations to B, C, and D as second customer end users, and D, thereafter as a first customer end user sends recommendations to E, and F as second customer end users, and F, thereafter as a first customer end user, sends recommendations to G and H as second customer end users, and wherein “*C” indicates that C as a second customer end user clicked through on the recommendation, and “!F” indicates that F performed an affirmative interaction with respect to the recommendation of the recommended web site.

The string may be stored as a linked list or as a set of elements and relations in a relational database.

The method and system of the invention can be for accumulating merchant-specific rewards and awards. This is a situation where points earned by recommending “friends” to a specific merchant and by “friend's” transactions with the specific merchant, and where the points can only be redeemed by that merchant, or, where “merchant” includes only the merchant to whom the “friend” is referred, and possibly, other merchants designated by that merchant. Alternatively, the method and system of the invention can also be used to administer an electronic version of the “scrip” system of the 1930's and 1940's, and the “trading stamp” system of the 1940's, 1950's, and 1960's, where points are awarded for referring a “friend” to any of a relatively large number of merchants and service providers, as well as for transactions and interactions with any of the relatively large number of merchants and providers. The rewards or awards or points are redeemable either centrally, or from some or all of the merchants or service providers utilizing the tracking services of invention, for example, through a single tracking vendor or through related tracking vendors.

### THE FIGURES

The invention may be understood by reference to the FIGURES attached hereto.

FIG. 1 is a view of the network architecture, showing customer client browsers, merchant client browsers/servers, an internet, a network server, an application server, a database server, and databases, including a tracking database and an object and applet database.

FIG. 2 is a high level view of the system, showing, a first customer, at merchant web site, recommending a second customer. The database entries to reflect the recommendation are made at the tracking server. The tracking server notifies the second customer and merchant. The second customer interacts with merchant's web site, and the appropriate database entries are made at tracking server.

FIG. 3 illustrates the platform origination modules.

FIG. 4 illustrates the platform action modules.

### DETAILED DESCRIPTION OF THE INVENTION

Overview of the Invention

The method and system described herein provides personal recommendation tracking, that is, customer recommendation tracking for third party sites, such as merchant sites, and also tracking of the actions of the individual recommended customers at the recommended sites, that is, whether the recommended customers merely view the site, whether they register at the site, whether they buy at the site, and whether they recommend the site to a still further recommended customer. This is tracked, and recorded, for assignment of premiums, points, and the like to the original recommender.

At a simple level, the method and system provide recommendation and result tracking, where an end user is at a merchant site, and decides to recommend the site to a friend, that is to “Tell A Friend.” The recommending end user does this by clicking on an appropriate icon. This action opens up a dialog box for the recommending end user to enter the friend's information, and his or her own information (if not supplied by an entry in the cookie.txt file) as well as the recommended site's information (also, if not supplied by an entry in a cookie.txt file).

An appropriate action by the recommender, e.g., a mouse click, transmits this information over the internet to the tracking server, where it is received and processed as necessary, for example, database entries are made, other database entries are retrieved, and data is transmitted from the tracking server to the merchant, the recommended end user, and the recommending end user.

Subsequently, the tracking server receives and stores recommended user's actions with the merchant, identifying the actions to the recommender or chain of recommenders, and assigning points to the recommender or chain of recommenders.

Additionally, the tracking server reports to the recommender(s) and the merchants of recommendations made by specific recommenders, and of activities and interactions by recommended customers—including web site visits, web site registrations, purchases, and subsequent recommendations. This is stored at the tracking server and is accessible as a recommending customer's bonus account.

As an illustration, Customer A visits XYZ.COM site, buys product, and thereafter Customer A uses an applet on XYZ.COM site to send e-mail to B, either directly, or through XYZ.COM's server, or through the tracking server, recommending XYZ.COM's product X to B. The tracking computer or tracking server places an “Encoded Recommendation Link” in the e-mail from A to B, so that when B opens e-mail and clicks on the “Encoded Recommended Link”, the link inserts a cookie marking Customer B as having been recommended by customer A, and the link then redirects Customer B to Product X at the XYZ.COM. If B buys product X, a single pixel GIF records Customer B's purchase of X, gives Customer A credit for recommending a “hot lead” who actually bought a product, and generates reports.

A further aspect of the method and system described herein is multi-level tracking and reporting, including multi level marketing with tracking of referrals across levels, and accounting for incentives across multi levels. This is accomplished using a “string” data structure, as will be more fully described below. The string data structure, which may be in the form of a relational database, an object oriented database, or a linked list database, and may have a tree hierarchy, facilitates tracking incentives and accounting for incentives in a multi-level marketing situation.

A further aspect of our invention is that merchants can integrate tracking into their site by a single-pixel transparent GIF, which serves to identify when a rewardable interaction has occurred, and the relevant recommender (including chains of recommenders), recommendee, merchant, and interaction

The method and system described herein is a customer acquisition and promotion tool that provides clients with a simple, turnkey system for deploying word-of-mouth campaigns on the Internet. The client controls all aspects of the campaign including campaign origination, reward structure, and reward fulfillment.

Campaigns using the method and system of the invention enable the customers of Merchant Clients or users to send email recommendations about their site or promotion to friends, and receive rewards when friends click through or take another Merchant Client-or Merchant User specified action. End-users are notified via email as they accrue rewards as their messages spread from friend to friend.

The method and system described herein supports several types of campaigns. The first campaign variable is origination method. The method and system described herein supports two origination methods:

Web site-originated campaigns allow a Merchant Client or Merchant User to place a “tell a friend” button or link in strategic areas of the Merchant Client's or Merchant User's web site. Customer Users who click on the button/link send email recommendations to friends, and receive rewards from the Merchant Client or Merchant User when their friends click through or take another Merchant Client-or Merchant User specified action.

Email-originated campaigns allow the Merchant Client or Merchant User to generate an email campaign with an embedded Recommendation Link which leads interested parties to the Merchant Client or Merchant User web site. Recipients can forward emails to their friends, and receive rewards from the Merchant Client or Merchant User when their friends click through or take another Merchant Client or Merchant User-specified action. For email list campaigns the method and system described herein can send multiple mailings to the list, excluding list members who have already taken action, and have requested to opt-out.

The second campaign variable is the action that triggers the reward. Rewards can be based on either:

a. A simple click-through action in which the friend clicks-through the link to the Merchant Client or Merchant User site and the sender receives a reward, or

b. A specific end-user action, such as registration or online purchase.

The third campaign variable is the reward method, which can either be:

a. Single level, in which the recommender receives a reward for an action from a recipient who received their email, or

b. Multi-level, in which the recommender receives an award each time their friend, their friend's friend, etc. takes an action.

The method and system described herein provides extensive reporting for every campaign, including (but not limited to):, number of unique recommenders, number of recommends, number of recommends per recommender, number of click-throughs, % click-through, number of actions, click to action rate, and % Actions

The method and system of the invention also provides assistance with list cleaning and opt-out tracking, providing Clients with regular reports on bad email addresses, bounced emails, and end-user opt-out requests.

Network Architecture

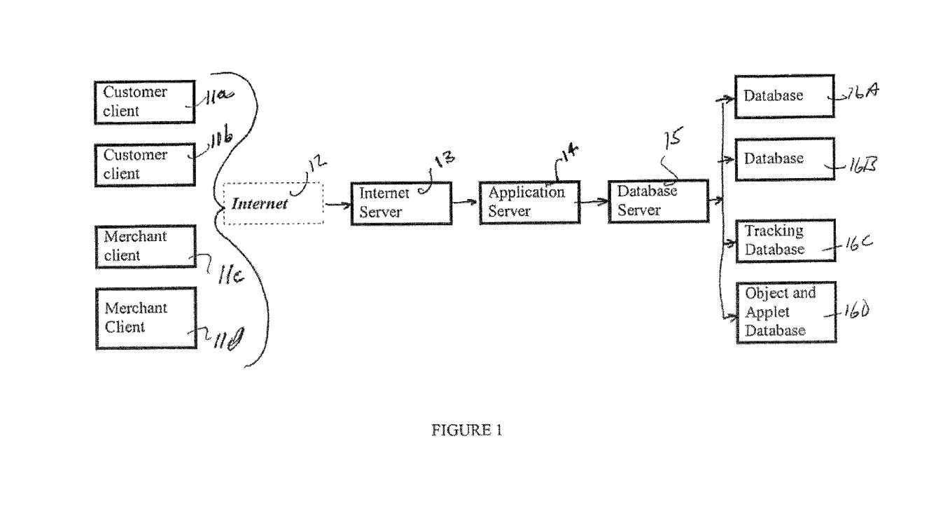

FIG. 1 is a view of the network architecture, showing customer client browsers, 11a, 11b, merchant client browsers/servers, 11c, 11d, an internet, 12, a network or internet server, 13, an application server, 14, a database server, 15, and databases, 16a, 16b, 16c, and 16d, including a tracking database, 16c, and an object and applet database, 16d.

System Architecture

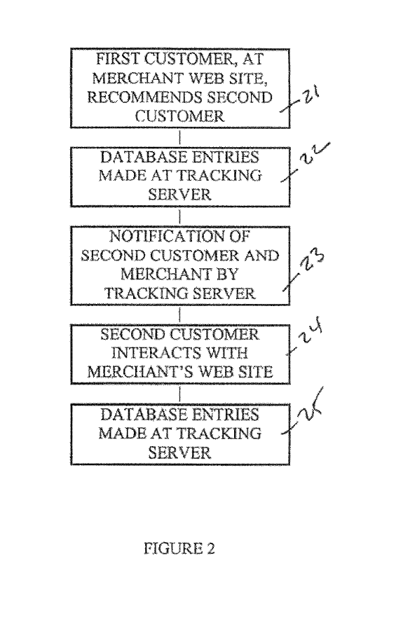

FIG. 2 is a high level view of the system, showing, a first customer, at merchant web site, recommending a second customer, 21. The database entries to reflect the recommendation are made at the tracking server, 22. The tracking server notifies the second customer and merchant, 23. The second customer interacts with merchant's web site, 24, and the appropriate database entries are made at the tracking server, 25.

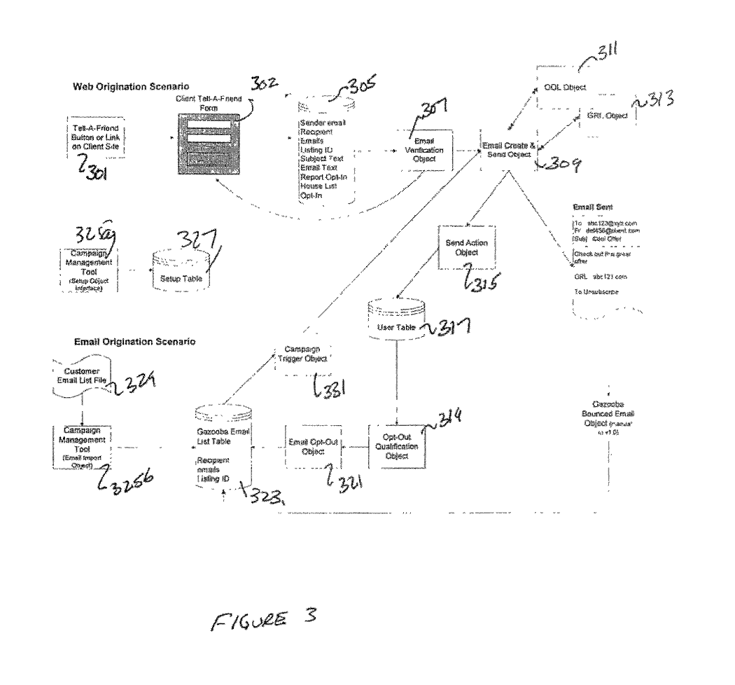

FIG. 3 shows a platform origination diagram for the method and system of the invention. The first step in a Web site-originated campaign is placing a “tell a friend” button or link 301 in strategic areas of the Merchant Client web site. Users who click on the button/link 301 send email recommendations to friends, and receive rewards from the Merchant Client when their friends click through or take another Merchant Client-specified action. In order to initiate this process, after clicking on the Tell-A-Friend link 301, the first or recommending customer is presented with a “Client Tell A Friend Form” 303.

The data in the Tell A Friend form 303 is received into a database 305 containing sending e-mail data, recipient e-mails, listing id's, text of e-mails, reports, and lists.

The e-mail verification object 307 is invoked when the user presses the Send button on the send form. The purpose of this function is to null check required sender and receiver, subject and body email fields in the send form. If any field is blank, end user receives a message or pop-up instructing them to fill in all required fields and is returned to send form. Successful completion results in a confirmation message or pop-up, and invokes the Email Create & Send Object 309. The object 307 is invoked by a Button Campaign Send Form, which Invokes the Email Create & Send Object 309. The Inputs include, a Listing ID, a Sender Email Address input by end user in e-mail form, a Receiver E-mail Addresses input by end user in email form, a Subject Text input by end user in email form, Email Body Text input by end user in email form, a Report opt-in: check box value from email form, Outputs, a Listing ID, a Sender Email Address, a Receiver Email Addresses, a Subject Text, a Email Body Text, and a Report opt-in value.

The Email Create And Send Object 309 generates and sends emails. invoking the GRL 311 and OOL 313 objects to insert the GRL (a resource locator) and OOL. In the case of a button campaign, it is invoked multiple times for each receiver email address. In the case of an email origination campaign, it is invoked multiple times for each email address in the Email List Table.

If button-originated, Send Action Object called to add sender and recipient and Listing ID to User Table, and report opt-in record set. All email sent by includes the following email header information: X-AntiSPAM, Errors-to, X-GVP-ID, From, To, Subject.

Thie E Mail Create and Send Object, 309 is Invoked By, an Email Verification Object 307, and a Campaign Trigger Object 3XX., A The E-mail create and send mail object, 309, in turn, invokes the GRL Object 311, an OOL Object 313, and the Send Action Object, 315. The Inputs to the E-Mail Create And Send Object 309 are a Reply-to Address, a From Set-up Table, a Sender Email Address, a From Email Verification Object (button origination campaigns only), a Recipient Email Address, a From Email Verification Object or Email List Table, a Report Opt-In Value, a GRL, a From GRL Object, a OOL, a From OOL Object (email origination campaigns only), a Campaign Origination Type, a From Set-up Table, a Subject Text, a Direct Email Subject text from Set-up Table if email originated, or user-input subject text, a from Email Verification Object, a Email Body Text, a Direct Email Body text from Set-up Table if email originated, or user-input email body text, from Email Verification Object, an Opt-out Text For Direct Email, a From Set-up Table, a Bad Email Manager email address, The outputs Outputs are a Appropriately formatted email sent, a Data to Send Action Object: Sender Email Address, Receiver Email Address, Listing ID, Report Opt-In Value, Date, Time.

A GRL is a resource locater and recommendation link. The GRL object 313 generates a unique GRL (recommendation link) for each sender and listing ID. Successful completion returns to Email Create & Send Object 309 to finish creating the email. This object is Invoked By the Email Create & Send Object 309 the End-User Report Object. The Inputs are the Sender Email Address, the Retrieved from Email Verification Object, the Recipient Email Address, and either the Retrieved from Email Verification Object 307 or the Email List Table, the Listing ID, and either the Retrieved from Email Verification Object or Email List Table. The outputs of the GRL object table are GRL's.

The Opt-Out Link (OOL) Object 311 generates a unique OOL for each email receiver and listing ID in cases where the sender is not the receiver's personal contact (Direct Email and Report). Successful completion returns to invoking object. The Opt-Out Link Object 311 is invoked by the Email Create & Send Object, 309, and the End-User Report Object. The Inputs are the Receiver Email Address, the Retrieved from Email Verification Object or Email List Table, the Listing ID, the Opt-out target URL location, and the Retrieved from Setup Table. The output is an OOL (Opt Out Link).

The Send Action Object 315 is invoked each time button campaign email is sent. It is invoked by Email Create & Send Object 309. The purpose is to update the User Table with the inputs below to record each send action from a button campaign. The Send Action Object 315 receives and writes to the User Table 317 the Sender Email Address, the Receiver Email Address, the Listing ID, the Report Opt-In Value, the Date, and the Time. After successful completion, control returns to Email Create & Send object, 308.

There is also an Opt-Out Qualification Object, 309, and an E-Mail Opt Out Object, 321, providing an input to an e-mail list table, 323. A campaign management tool, 325a, for a set-up object interface, provides input to a Set-Up Table, 327, while a customer E-Mail List File, 329, is inputted through an E-Mail Input Object Campaign Management Tool, 325b, to E-Mail list tables 323.

Although not shown in FIG. 3, there is a Click-through Object which is invoked when a user clicks through GRL and is redirected. The purpose is to cookie the user and record the click through action in the User Table, recording Sender Email Address, and the Recipient Email Address and Listing ID. It is invoked by the user clicking through on the GRL, and, in turn, invokes the End-user report object (if End User Report Trigger=click-through). The inputs include a GRL, an End User Report Trigger from the Set-Up Object, and Outputs a Sender Email Address which Creates/updates record in User Table, and is retrieved from an Encoded GRL, and a Recipient Email Address which Creates/updates a record in User Table that is retrieved from an Encoded GRL. The Listing ID Creates/updates record in User Table that retrieved from the Encoded GRL, the User is redirected to target URL read from the GRL and, most importantly to the Customer-User, the Reward action field in User Table is updated for the click-through.

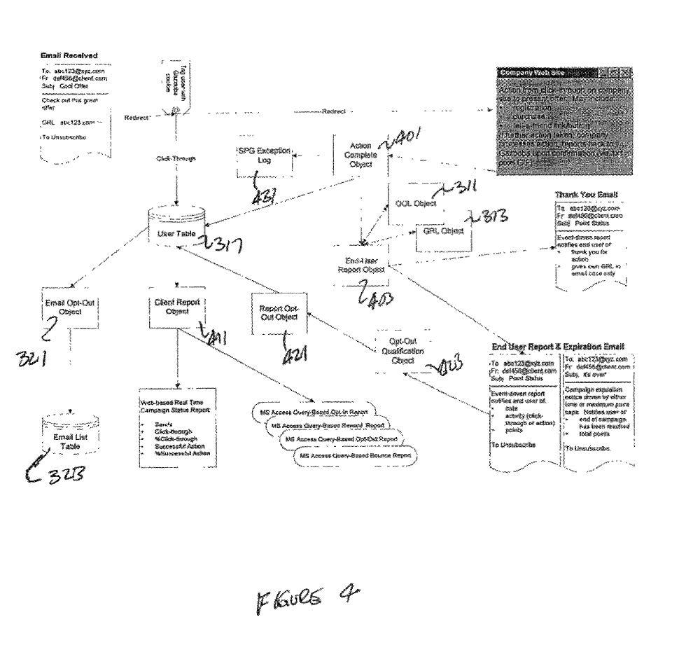

FIG. 4 continues the Platform Action Diagram of FIG. 3, working from an Action Complete Object 401 Serves the 1×1 pixel GIF to the Action Confirm screen onto the Merchant Client's site, reads coded information thrown from the Merchant Client site, and reads appropriate cookie information from user's browser. The Action Complete Object 401 records the action in the User Table, 317, reads the No Cookie Toggle from Setup Object and passes appropriate Report and Thank You Email requests to the End-User Report Object, 403. Action Complete Object, 401, is invoked by a 1×1 pixel GIF serve request from Client site, and in turn, the Action Complete Object 401 invokes the End-User Report Object, 403. This is in response to the inputs of Action Capture URLs retrieved from the Setup Table, 327, with Cookie information, including: GRL contents (sender email address, Listing ID), as well as such GIF encoded information as the recipient email address, date, time, key, listID, memo, and the No Cookie Toggle. The outputs include the Sender Email Address which creates/updates record in User Table, 317, retrieved from cookie; the Recipient Email Address which creates/updates a record in User Table, 317, retrieved from GIF, a Listing ID which creates/updates record in User Table retrieved from cookie, passes the Sender Email Address, Recipient Email Address, and Listing ID to End-User Report Object, 403, and, again, most importantly to the Customer end-user, the reward action field in the User Table, 317, is updated for action.

The Action Complete Object 401, calls the End User Report Object 403, which creates and sends two types of end-user notifications: a “Thank You” Email (direct email case only) to the action taker (Recipient) and an “End User Email Report” to the merchant-user whose GRL the action taker came in on. In cases where the action taker did not come in on a GRL, no End-User Report is generated. The “Thank You” Email includes a GRL but does not include an OOL. “End User Email Reports” contain an OOL and a GRL for direct email-originated campaigns but not for button campaigns. The End User Report Object, 403, is invoked by the Action Complete Object 401, and, in turn, invokes the GRL Object, 313, and the OOL Object, 311. The Inputs to the End User Report Object 403 are the Sender Email Address, which is passed from Action Complete Object 401, and the Recipient Email Address, which is also passed from Action Complete Object, 401, as well as the Listing ID which is also passed from Action Complete Object 401. The outputs are the Thank You Email, and the End User Report Email.

The Client Report Object, 411, shown in FIG. 4, produces all merchant-client-facing reports including: real-time campaign status, reward, opt-in, opt-out, and bounced email. The real-time campaign status report is a Web page, which queries the user table to compile information below. The Client Report Object, 411, is invoked by the Real-time campaign status report, automatically, and in real-time, as well as by vendored and legacy reporting databses tools, such as MS Access/Excel reports and the like. The inputs are User table data and Set-up table data, and the outputs are a real-time campaign status report (typically and preferably Web based) and data base reports (typically MS Access/Excel reports) for reward, opt-in, opt-out, and bounced email, plus the Scrubbed email list.

The Email Opt-out Object, 321, sets the email opt-out flag in user table, eliminating address from send list for future emails (email-originated only). It removes email address from Email List table. The e-Mail Opt Out Object is invoked by a click -through on Direct Email OOL or reply-to email with an opt-out request for email. Its input is an OOL, and its output is to the user table and the Email List Table.

The Report Opt-out Object, 421, sets the report opt-out flag in user table on, preventing automatic reporting to end-user. It is invoked by clicking on Report OOL or replying-to email with opt-out request for report email. The input is the OOL, and the output is to the User Table, 317.

The Opt Out Qualification Object, 423,is a gate, which qualifies users before allowing them access to the Email Opt-Out Object and the Report Opt-Out Object. It takes the form of a Web page with an email address input. It intakes the user's address and compares it to that of the OOL they came in on. This comparison is case insensitive. If the two match, it passes the user on to the Email Opt-Out Object, 321, or Report Opt-Out Object, 421, as appropriate. It is invoked by a user's click on an OOL, where the inputs are the consumer-users email address in a form, and the Consumer-user's email address from OOL In a positive ID case, the user is sent to either Email Opt-Out Object, 321, or Report Opt-Out Object, 421, while in a negative ID case the user receives an error message.

The SPG Exception Log is used to write a script so that system log will automatically send notification when SPG isn't thrown correctly. Typical exception cases are the hash did not match, there was no cookie, the cookie had the wrong cookie id, the cookie had the wrong cookie format, or there was an incomplete spg parameter set. The Log fields are Date & Time, Campaign ID, and one of the exception cases. The SPG Exception Log is invoked by the Action Complete Object (SPG Receiver Program) with an input of SPG data, and an output of one log entry per exception case.

Data Structures

The database server, which contains the tracking capability, that is, the tracking server or the tracking database, stores the referral, including multi-level referrals, and interaction data as strings of the form

A=B+*C+D(E+!F(G+H))

where A represents the first customer end user, and B, C, D, E, and F represent second customer end users, where A sends recommendations to B, C, and D as second customer end users, and D, thereafter as a first customer end user sends recommendations to E, and F as second customer end users, and F, thereafter as a first customer end user, sends recommendations to G and H as second customer end users, and wherein “*C” indicates that C as a second customer end user clicked through on the recommendation, and “!F” indicates that F performed an affirmative interaction with respect to the recommendation of the recommended web site.

The string may be stored as a linked list or as a set of elements and relations in a relational database.

While the invention has been described with respect to certain preferred embodiments and exemplifications, it is not intended to limit the scope of the invention thereby, but solely by the claims appended hereto.

We claim:

1. A method of tracking recommendations over a network of web sites by a first user at a first browser to a second user at a second browser, both of said users being on the network, said method comprising the steps of:
a) receiving at a tracking server a recommendation of a web site from the first user, recommendation data of the recommended web site and data of the user at the second browser for whom the recommendation is made;
b) storing at the tracking server data about the first user at the first browser, the second user at the second browser, and the recommended web site; and
c) providing to the second user at the second browser an applet having a link to the recommended web site.

2. The method of claim 1 comprising identifying the first user at the first browser to the second user at the second browser as the recommender of the second user at the second browser to the web site.

3. The method of claim 2 comprising identifying the first user at the first browser to the recommended web site as the recommender of the second user at the second browser to the web site.

4. The method of claim 2 comprising identifying the first user at the first browser as the recommender of the second user at the second browser to the tracking server.

5. The method of claim 2 wherein the applet provided to the second user at the second browser with a link to the recommended web site identifies the first user at the first browser as the recommender of the second user at the second browser to the web site.

6. The method of claim 1 comprising identifying the interaction of the second user at the second browser with respect to the recommendation of the recommended web site.

7. The method of claim 7 wherein the interaction of the second user at the second browser with respect to the recommendation of the recommended web site is chosen from the group consisting of: a click through and an affirmative act.

8. The method of claim 1 comprising identifying the first user at the first browser as the recommender of the second user at the second browser to one or both of the recommended web site and the tracking server; identifying the interaction of the second user at the second browser with respect to the recommendation of the recommended web site; and storing the identities of the first user at the first browser, the second user at the second browser, and the interaction of the second user at the second browser with respect to the recommendation of the recommended web site.

9. The method of claim 9 comprising storing the identities of the first user at the first browser, the second user at the second browser, the recommended web site, and the interaction taken by the second user at the second web site as a string.

10. The method of claim 10 wherein the string is of the form
A=B+*C+D(E+!F(G+H))
where A represents the first user at the first browser, and B, C, D, E, and F represent second users at second browsers, where A sent referrals to B, C, and D as second users at second browsers, and D, thereafter as a first user at a first browser sent referrals to E, and F as second users at second browsers, and F, thereafter as a first user at a first browser, sent referrals to G and H as second users at second browsers, and wherein “*C” indicates that C as a second user at a second browser clicked through on the referral, and “!F” indicates that F performed an affirmative interaction with respect to the recommendation of the recommended web site.

11. The method of claim 11 comprising storing the string as a linked list.

12. The method of claim 11 comprising storing the string as a set of elements and relations in a relational database.

13. The method of claim 10 comprising assigning interaction values to interactions taken by second users referred to a web site by a first user, and assigning referral values to the first user based upon the interactions taken by the second users referred to web sites by the first user.
A1. A method of tracking recommendations of e-commerce merchants by one customer to another customer, said customers having identifying text data (cookies) said method comprising the steps of:
a) receiving at a tracking server a recommendation of a merchant web site from a first customer to a second customer, said recommendation including recommendation data of the recommended merchant web site and identification data of the second customer for whom the recommendation is made;
b) storing at the tracking server identification data data of the first customer, the second customer, and the recommended merchant web site; and
c) providing to the second customer an applet having a link to the recommended merchant web site, said applet further identifying the first customer as the recommender of the second customer to the e-commerce merchant web site, and
d) identifying the interaction of the second customer with respect to the recommendation to the recommended e-commerce merchant web site,
e) storing the identities of the first user at the first browser, the second user at the second browser, the recommended web site, and the interaction taken by the second user at the second web site as a string of the form
A=B+*C+D(E+!F(G+H))
where A represents the first customer, and B, C, D, E, and F represent second customers, where A sent referrals to B, C, and D as second customers, and D, thereafter as a first customer sent referrals to E, and F as second customers, and F, thereafter as a first customer, sent referrals to G and H as second customers, and wherein “*C” indicates that C as a second customer clicked through on the referral, and “!F” indicates that F performed an affirmative interaction with respect to the recommendation of the recommended web site,
f) assigning interaction values to interactions taken by second customers referred to a web site by a first customer, and assigning referral values to the first customerbased upon the interactions taken by the second customers referred to web sites by the first customer.

15. The method of claim 14 comprising identifying the first customer to the second customer as the recommender of the second customer to the merchant web site.

16. The method of claim 14 comprising identifying the first customer to the merchant as the recommender of the second customer.

17. The method of claim 14 wherein the interaction of the second user at the second browser with respect to the recommendation of the recommended web site is chosen from the group consisting of: a click through and an affirmative act.

18. The method of claim 14 comprising storing the string as a linked list.

19. The method of claim 14 comprising storing the string as a set of elements and relations in a relational database.

20. A system controlled and configured for interacting with customer end user computers and merchant end user computers whereby merchant end user information and merchant end user recommendations are received from a first customer end user computer and forwarded, with an added hypertext link, to a second customer end user computer, and to store customer end user and merchant information end user information, and customer end user—merchant end user interactions, said system comprising:
a) a host server adapted to
i) receive recommendations from the first customer end user browser,
ii) transmit a hypertext link implementing the recommendations to the second customer end user browser and to the recommended merchant end user, and
iii) receive customer end user—merchant end user interaction data from the second end user;
b) a database server including:
i) one or more business object databases including hypertext links for sending customer end user data and receiving interaction data, an e-mail database, an e-mail address list table, a user table, and
ii) a tracking database for receiving and recording first customer end user recommendations and second customer end-user interactions, and providing data for customer end user reports.

21. The system of claim 20 wherein the system is controlled and configured to deliver hypertext links to the second customer end user, which hypertext links are recommendation links that mark the second customer end user as having been recommended to the merchant end user using a cookie.

22. The method of claim 21 wherein the system is controlled and configured to redirect the second customer end user to the merchant end user using the cookie.

23. The system of claim 21 wherein the system is controlled and configured to receive indicia of second customer end user interactions with the merchant end user.

24. The system of claim 20 wherein the tracking database is configured and controlled to store the identities of the first customer end user, the second customer end user, the merchant end user, and the interaction taken by the second customer end user with the merchant end user as a string.

25. The system of claim 24 wherein the string is of the form
A=B+*C+D(E+!F(G+H))
where A represents the first customer end user, and B, C, D, E, and F represent second customer end users, where A sends recommendations to B, C, and D as second customer end users, and D, thereafter as a first customer end user sends recommendations to E, and F as second customer end users, and F, thereafter as a first customer end user, sends recommendations to G and H as second customer end users, and wherein “*C” indicates that C as a second customer end user clicked through on the recommendation, and “!F” indicates that F performed an affirmative interaction with respect to the recommendation of the recommended web site.

26. The system of claim 25 wherein the system is controlled and configured to store the string as a linked list.

27. The system of claim 25 wherein the system is controlled and configured to store the string as a set of elements and relations in a relational database.

28. The system of claim 20 wherein the system is further controlled and configured to assign interaction values to interactions taken by second customers referred to a web site by a first customer, to assign referral values to the first customer based upon the interactions taken by the second customer referred to web sites by the first customer, and to store values assigned to the first customer.
